(19) United States
(12) Patent Application Publication
(10) Pub. No.: US 2025/0326987 A1
(43) Pub. Date: Oct. 23, 2025

(54) LAUNDRY DETERGENT COMPOSITIONS

(71) Applicant: The Procter & Gamble Company, Cincinnati, OH (US)

(72) Inventors: Victor Manuel ARREDONDO, Madeira, OH (US); Phillip Kyle VINSON, Fairfield, OH (US)

(21) Appl. No.: 19/185,473

(22) Filed: Apr. 22, 2025

Related U.S. Application Data
(60) Provisional application No. 63/637,401, filed on Apr. 23, 2024.

(30) Foreign Application Priority Data
Apr. 30, 2024 (EP) 24173225.4

(51) Int. Cl. C11D 1/18; C11D 1/14; C11D 1/83

(52) U.S. Cl. CPC C11D 1/18; C11D 1/143; C11D 1/8305; C11D 2111/12

(57) ABSTRACT

The need for liquid laundry detergent compositions which provide good removal of both hydrophobic and hydrophilic stains, while also comprising reduced levels of 1,4-dioxane, or even no 1,4-dioxane, is met by formulating the laundry detergent composition with a combination of sulfonate anionic surfactant and an alkyl alkanolamide sulfate anionic surfactant.

### FIELD OF THE INVENTION

Liquid laundry detergent compositions or unit dose articles comprising them.

### BACKGROUND OF THE INVENTION

Laundry detergent compositions have typically been formulated using anionic surfactant comprising a combination of sulfonate anionic surfactant and alkyl ethoxylated sulfate anionic surfactant. The combination of sulfonate surfactant, such as linear alkyl benzene sulfonate, and alkyl ethoxylated sulfate anionic surfactants is used to provide both good removal of both hydrophobic stains and hydrophilic stains. Hydrophobic stains include greasy stains such as animal grease, and make-up, while hydrophilic stains include such stains as clay, and sebum. The combination of sulfonate anionic surfactant and alkyl ethoxylated sulfate anionic surfactant has also been found to improve the removal of enzymatic stains such as grass, chocolate, and starch containing stains.

However, processes to make alkyl ethoxylated sulfate anionic surfactants often result in residual amounts of 1,4-dioxane by-product being present. The amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps.

An alternative is to use alkyl sulfate anionic surfactants which comprise only low levels of ethoxylation, or even being free of ethoxylation. However, formulating with such alkyl sulfate anionic surfactants, having little or no ethoxylation, can lead to reduced performance, especially for greasy stains and reduced physical stability at lower temperatures.

As such, there remains a need for liquid hand dishwashing compositions which provides both good removal of hydrophobic stains, especially greasy stains, while comprising reduced levels or even no 1,4-dioxane.

U.S. Pat. No. 2,843,550A relates to detergent compositions consisting essentially of alkali metals of sulfated C2-C3 alkylolamides of C14-C18 hydrogenated tallow fatty acids, alkali metal C9-C18 monoalkyl benzene sulfonate detergent, the former being present in an amount, by weight, of about 15% to 50% and the latter, 50% to 85%, by weight, of the total of the two, and as a foam-improving agent\, about 5% to 70%, by weight, based on the sulfated alkylolamide salt, or a normal, saturated C10-C18 aliphatic alcohol. EP4253510A relates to a liquid hand dishwashing detergent composition comprising a higher fraction of components derived from natural, renewable sources, ideally also having improved biodegradability, and still providing good sudsing, grease removal, and low temperature stability, while not substantially changing the viscosity profile, the composition comprising a surfactant system which comprises anionic surfactant, the anionic surfactant comprising a combination of alkyl sulfate anionic surfactant and acyl taurate anionic surfactant. The synthesis of sulfated alkanolamides is described in “Synthesis and properties of sulfated alkanolamides” Journal of the American Oil Chemists' Society volume 47, pages 91-93 (1970), and “Synthesis and Properties of N-Alkyl Amide Sulfates” Langmuir 1999, 15, 20, 6664-6670.

### SUMMARY OF THE INVENTION

The present invention relates to a liquid laundry detergent composition comprising a surfactant system, wherein the surfactant system comprises anionic surfactant, wherein the anionic surfactant comprises a combination of alkyl alkanolamide sulfate anionic surfactant and sulfonate anionic surfactant, wherein alkyl alkanolamide sulfate anionic surfactant has the formula:

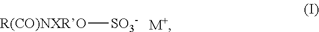

wherein: R is an alkyl chain comprising a number average of from 7 to 17 carbon atoms; R′ is an alkyl chain comprising a number average of from 1 to 3 carbon atoms; X is H or C1 to C3 alkyl; and M⁺ is a counterion.

### DETAILED DESCRIPTION OF THE INVENTION

The laundry detergent compositions of the present invention provide good removal of both hydrophobic and hydrophilic stains, while also comprising reduced levels of 1,4-dioxane, or even no 1,4-dioxane.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

All measurements are performed at 25° C. unless otherwise specified.

As used herein, the articles including “a” and “an” when used in a claim, are understood to mean one or more of what is claimed or described.

### Laundry Detergent Composition:

The laundry detergent composition can be in any suitable form, such as liquid, paste, granular, solid, powder, or in conjunction with a carrier such as a substrate. Preferred laundry detergent compositions are either liquid or granular, with liquid being most preferred.

As used herein, “liquid detergent composition” refers to liquid detergent composition, which is fluid, and preferably capable of wetting and cleaning a fabric, e.g., clothing in a domestic washing machine. As used herein, “laundry detergent composition” refers to compositions suitable for washing clothes. The composition can include solids or gases in suitably subdivided form, but the overall composition excludes product forms which are non-fluid overall, such as tablets or granules. The liquid laundry detergent composition preferably has a density in the range from 0.9 to 1.3 grams per cubic centimetre, more specifically from 1.00 to 1.10 grams per cubic centimetre, excluding any solid additives but including any bubbles, if present.

The composition can be an aqueous liquid laundry detergent composition. For such aqueous liquid laundry detergent compositions, the water content can be present at a level of from 5.0% to 95%, preferably from 25% to 90%, more preferably from 50% to 85% by weight of the liquid detergent composition.

The pH range of the detergent composition is from 6.0 to 8.9, preferably from pH 7 to 8.8.

The detergent composition can also be encapsulated in a water-soluble film, to form a unit dose article. Such unit dose articles comprise a detergent composition of the present invention, wherein the detergent composition comprises less than 20%, preferably less than 15%, more preferably less than 10% by weight of water, and the detergent composition is enclosed in a water-soluble or dispersible film. Such unit-dose articles can be formed using any means known in the art. Suitable unit-dose articles can comprise one compartment, wherein the compartment comprises the liquid laundry detergent composition. Alternatively, the unit-dose articles can be multi-compartment unit-dose articles, wherein at least one compartment comprises the liquid laundry detergent composition.

### Surfactant System

The laundry composition can comprise the surfactant system at a level of from 2.5% to 60%, preferably from 10.0% to 50%, more preferably from 15.0% to 45% by weight of the composition.

Suitable surfactants as used herein means surfactants or mixtures of surfactants that provide cleaning, stain removing, or laundering benefit to soiled material. Suitable detersive surfactants can be: anionic surfactant, nonionic surfactant, amphoteric and/or zwitterionic surfactant, and combinations thereof.

Preferably surfactants comprising saturated alkyl chains are used.

### Anionic Surfactant

The surfactant system comprises anionic surfactant. The surfactant system can comprise anionic surfactant at a level of from 2.0% to 50%, preferably from 4.0% to 40%, more preferably from 6.0% to 30% of the liquid laundry detergent composition.

The anionic surfactant comprises alkyl alkanolamide sulfate anionic surfactant and sulfonate anionic surfactant. The combination of the alkyl alkanolamide sulfate anionic surfactant and the sulfonate anionic surfactant has been found to provide improved removal of several greasy stains while still providing good removal of hydrophilic stains, without introducing 1,4-dioxanes into the composition. Preferably, the anionic surfactant can comprise the sulfonate anionic surfactant and the alkyl alkanolamide sulfate anionic surfactant in a weight ratio of from 55:45 to 99:1, preferably from 60:40 to 95:5, and most preferably from 70:30 to 85:15.

The sulfonate anionic surfactant can be present at a level of from 30% to 90%, preferably from 40% to 70% by weight of the surfactant system. The sulfonate anionic surfactant can be present at a level of at least 55%, preferably from 60% to 90%, more preferably from 70% to 85% by weight of the anionic surfactant.

Anionic sulphonate or sulphonic acid surfactants suitable for use herein include the acid and salt forms of alkylbenzene sulphonates, alkyl ester sulphonates, alkane sulphonates, alkyl sulphonated polycarboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates, C6-C22 primary or secondary alkane sulphonates, C5-C20 sulphonated polycarboxylic acids, and any mixtures thereof, but preferably C11-C13 alkylbenzene sulphonates. The aforementioned surfactants can vary widely in their 2-phenyl isomer content.

The alkyl alkanolamide sulfate anionic surfactant of use in the present invention has the formula:

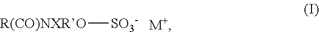

wherein:
R is an alkyl chain comprising a number average of from 7 to 17 carbon atoms, preferably R is an alkyl chain comprising a number average of from 9 to 13, more preferably from 11 to 13 carbon atoms, and most preferably R is a blend of C11 and C13 alkyl chains;
R′ is an alkyl chain comprising a number average of from 1 to 3 carbon atoms, preferably R′ is an alkyl chain comprising a number average of from 2 to 3 carbon atoms, more preferably wherein R′ is selected from the group consisting of: —(CH₂)₂—, —CH₂CH(CH₃)—, —CH(CH₃)CH₂—;
X is H or C1 to C3 alkyl, preferably X is H or C1 alkyl, more preferably H or methyl;
M⁺ is a counterion, preferably M⁺ is an alkali metal counterion or ammonium, ethanolamine, or isopropanolamine, more preferably Na⁺, or K⁺, Mg²⁺, or ethanolamine, most preferably Na⁺.
R can be derived from suitable starting fatty acids such as lauric acid (C12), myristic acid (C14), palmitic acid (C16), stearic acid (C18), palmitoleic acid (C16:1), oleic acid (C18:1), and mixtures thereof. If the starting fatty acid is naturally derived, the starting fatty acid will typically have a distribution of chain lengths, such as from 8 to 18 carbon atoms, or narrower if refined to achieve the desired alkyl chain length distributions. Lauric acid (C12), myristic acid (C14), and especially mixtures thereof are preferred. Since the carbon chain count of the fatty acid includes the carbon atom of the carboxylic acid of the fatty acid, the carbon count of R in formula (I) of the alkyl alkanolamide sulfate surfactant is one less than the carbon count of the fatty acid. For instance, if the alkyl alkanolamide surfactant was formed using lauric acid (C12), R in formula (I) of the alkyl alkanolamide sulfate surfactant would be C11 alkyl. R can be saturated or unsaturated.

The alkyl chain R can have a mol percentage of C13 alkyl chains to total alkyl chains of at least 20%, preferably at least 30%, more preferably at least 40%, most preferably at least 50%. The molar ratio of C13 to C11 alkyl chains in R can be from 3:1 to 1:4 preferably from 2:1 to 1:1. In the alkyl alkanolamide sulfate anionic surfactant, the alkyl chain R can have a mole percentage of C15 and C17 alkyl chains to total alkyl chains of less than 40%, preferably from 10% to 40%, more preferably from 20% to 40%. A small mole percentage of the longer alkyl chains are believed to improve cleaning efficacy.

R can be a linear alkyl chain. For instance, to improve grease cleaning. As such, R can be naturally derived from renewable feedstock such as coconut oil, palm kernel oil, and mixtures thereof, with coconut oil being preferred.

Alternatively, but less preferred alkyl chain of R can be branched or a blend of linear or branched. For instance, to improve low temperature stability of the resultant detergent composition. A combination of good grease cleaning and improved low temperature stability of the detergent composition can be achieved when alkyl chains having a weight average degree of branching of at least 15%, preferably from 20% to 60%, more preferably from 30% to 50%, is used for R. The weight average degree of branching for the R group is calculated using the same methodology as described later for alkyl sulfate anionic surfactants. The weight average degree of branching and the distribution of branching can typically be obtained from the technical data sheet for the constituent fatty acid used to make the alkyl alkanolamide sulfate anionic surfactant. Alternatively, the type of branching can also be determined through analytical methods known in the art, including capillary gas chromatography with flame ionisation detection on medium polar capillary column, using hexane as the solvent.

The alkyl alkanolamide sulfate anionic surfactant preferably comprises C12 alkyl alkanolamide sulfate anionic surfactant, C14 alkyl alkanolamide sulfate anionic surfactant, and mixtures thereof, with a blend of C12 alkyl alkanolamide sulfate anionic surfactant and C14 alkyl alkanolamide sulfate anionic surfactant being preferred. As such, R in formula (I) is preferably C11 or C13, or a combination thereof.

Suitable C12 alkyl alkanolamide sulfate anionic surfactant can be selected from the group consisting of: N-(2-hydroxyethyl)dodecanamide sulfate, N-(2-hydroxypropyl)dodecanamide sulfate, N-(2-hydroxyethyl)-N-methyldodecanamide sulfate, N-(1-hydroxypropan-2-yl)dodecanamide sulfate, and mixtures thereof, preferably N-(2-hydroxyethyl)dodecanamide sulfate, N-(2-hydroxypropyl)dodecanamide sulfate, N-(2-hydroxyethyl)-N-methyldodecanamide sulfate, and mixtures thereof.

Suitable C14 alkyl alkanolamide sulfate anionic surfactant can be selected from the group consisting of: N-(2-hydroxyethyl)tetradecanamide sulfate, N-(2-hydroxypropyl)tetradecanamide sulfate, N-(2-hydroxyethyl)-N-methyltetradecanamide sulfate, N-(1-hydroxypropan-2-yl) tetradecanamide sulfate, and mixtures thereof, preferably N-(2-hydroxyethyl) tetradecanamide sulfate, N-(2-hydroxypropyl) tetradecanamide sulfate, N-(2-hydroxyethyl)-N-methyltetradecanamide sulfate, and mixtures thereof.

The anionic surfactant can further comprise alkyl sulfate anionic surfactant. The alkyl sulfate anionic surfactant can have a number average alkyl chain length of from 10 to 18, preferably from 12 to 15 carbon atoms. Anionic sulphate salts suitable for use in the compositions of the invention include the primary and secondary alkyl sulphates, having a linear or branched alkyl or alkenyl moiety. Also useful are beta-branched alkyl sulphate surfactants or mixtures of commercially available materials, having a weight average (of the surfactant or the mixture) branching degree of at least 50%.

The alkyl sulfate anionic surfactant can have an average degree of alkoxylation of less than 3.0, preferably less than 1.5, more preferably less than 0.5, even more preferably less than 0.1, and most preferably wherein the alkyl sulfate anionic surfactant is free of alkoxylation.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Preferred low ethoxylation alkyl sulphate surfactants can comprise branched or linear alkyl sulphate surfactant. The branched alkyl sulphate surfactant can comprise at least 20%, preferably from 60% to 100%, more preferably from 80% to 90% by weight of the alkyl chains of the branched alkyl sulphate surfactant of 2-branched alkyl chains. Such branched alkyl sulphates with 2-branched alkyl chains can also be described as 2-alkyl alkanol sulphates, or 2-alkyl alkyl sulphates. The branched alkyl sulphates can be neutralized by sodium, potassium, magnesium, lithium, calcium, ammonium, or any suitable amines, such as, but not limited to monoethanolamine, triethanolamine and monoisopropanolamine, or by mixtures of any of the neutralizing metals or amines. Suitable branched alkyl sulphate surfactants can comprise alkyl chains comprising from 10 to 18 carbon atoms (C10 to C18) or from 12 to 15 carbon atoms (C12 to C15), with 13 to 15 carbon atoms (C13 to C15) being most preferred. The branched alkyl sulphate surfactant can be produced using processes which comprise a hydroformylation reaction in order to provide the desired levels of 2-branching. Particularly preferred branched alkyl sulphate surfactants comprise 2-branching, wherein the 2-branching comprises from 20% to 80%, preferably from 30% to 70%, more preferably from 40% to 65% by weight of the 2-branching of methyl branching, ethyl branching, and mixtures thereof.

Suitable low ethoxylated branched alkyl sulphate surfactants can be derived from alkyl alcohols such as Lial® 145, Isalchem® 145, both supplied by Sasol, optionally blending with other alkyl alcohols in order to achieve the desired branching distributions.

The surfactant system can comprise less than 3.0%, preferably less than 2.0%, more preferably from 0.5% to 1.5% by weight of the composition of fatty acid.

However, by nature, every anionic surfactant known in the art of detergent compositions may be used, such as disclosed in “Surfactant Science Series”, Vol. 7, edited by W. M. Linfield, Marcel Dekker. Other suitable anionic surfactants for use herein include fatty methyl ester sulphonates and/or alkyl polyalkoxylated carboxylates, for example, alkyl ethoxylated carboxylates (AEC).

The anionic surfactants are typically present in the form of their salts with alkanolamines or alkali metals such as sodium and potassium.

Amphoteric and/or Zwitterionic Surfactant

The surfactant system can comprise amphoteric and/or zwitterionic surfactant at a level of from 0.1% to 2.0%, preferably from 0.1% to 1.0%, more preferably from 0.1% to 0.5% by weight of the liquid laundry detergent composition.

Suitable amphoteric surfactants include amine oxide surfactants. A mine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide (lauryl dimethylamine oxide), commercially available from Albright & Wilson, C₁₂-C₁₄ amine oxides commercially available under the trade name Genaminox® LA from Clariant or AROMOX® DMC from AKZO Nobel.

Suitable amphoteric or zwitterionic detersive surfactants include those which are known for use in hair care or other personal care cleansing. Non-limiting examples of suitable zwitterionic or amphoteric surfactants are described in U.S. Pat. Nos. 5,104,646, 5,106,609. Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulphonate, sulphate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

### Nonionic Surfactant

The surfactant system can comprise nonionic surfactant. The level of nonionic surfactant in the liquid detergent composition can be present at a level of less than 5.0%, preferably from 0.5% to 4.0%, more preferably from 1.0% to 3.0% by weight of the composition.

The nonionic surfactant is preferably selected from alkoxylated alkyl alcohol nonionic surfactant, alkyl polyglucoside, and mixtures thereof, more preferably wherein the nonionic surfactant comprises alkyl polyglucoside nonionic surfactant.

Suitable alkoxylated alkyl alcohol nonionic surfactant include C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

For improved whiteness, the alkyl polyglucoside surfactant can have a number average alkyl carbon chain length from 8 to 16, preferably from 10 to 14, most preferably from 12 to 14, with an average degree of polymerization of from 0.1 to 3.0, preferably from 1.0 to 2.0, most preferably from 1.2 to 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSU P/MB, and Glucopon® 650 EC/MB, from BASF Corporation).

Alkylpolysaccharides such as disclosed in U.S. Pat. No. 4,565,647 Llenado are also useful nonionic surfactants in the compositions of the invention.

### Optional Ingredients

The detergent composition may additionally comprise one or more of the following optional ingredients: dye fixative polymer, external structurant or thickener, enzymes, enzyme stabilizers, cleaning polymers, optical brighteners, hueing dyes, particulate material, perfume and other odour control agents, hydrotropes, suds suppressors, fabric care benefit agents, pH adjusting agents, dye transfer inhibiting agents, preservatives, non-fabric substantive dyes and mixtures thereof. The laundry detergent composition preferably does not comprise a bleach.

External structurant or thickener: Preferred external structurants and thickeners are those that do not rely on charge-charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants.

Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof.

Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s-1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s-1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics and/or suspension of the soils. Non-limiting examples of suitable cleaning polymers include: amphiphilic alkoxylated grease cleaning polymers; clay soil cleaning polymers; soil release polymers; and soil suspending polymers. A preferred cleaning polymer is obtainable by free-radical copolymerization of at least one compound of formula (I),

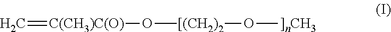

in which n is equal to or greater than 3 for a number, with at least one compound of formula (II),

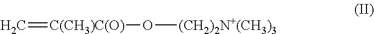

in which A⁻ represents an anion, in particular selected from halides such as fluoride, chloride, bromide, iodide, sulphate, hydrogen sulphate, alkyl sulphate such as methyl sulphate, and mixtures thereof. Such polymers are further described in EP3196283A1.

For similar reasons, polyester based soil release polymers, such as SRA300, supplied by Clariant are also particularly preferred.

Other useful cleaning polymers are described in US20090124528A1. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulphated versions thereof. Polypropoxylated derivatives may also be included. A wide variety of amines and polyalkyleneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8.0%, more preferably from 0.1% to 2.0%, by weight of the detergent composition, of the cleaning polymer.

Polymer Deposition Aid: The laundry detergent composition can comprise from 0.1% to 7.0%, more preferably from 0.2% to 3.0%, of a polymer deposition aid. As used herein, “polymer deposition aid” refers to any cationic polymer or combination of cationic polymers that significantly enhance deposition of a fabric care benefit agent onto the fabric during laundering. Suitable polymer deposition aids include a cationic polysaccharide and/or a copolymer, with cationic polysaccharide being preferred. The cationic polymer can also be selected from the group consisting of: poly (diallyldimethylammonium chloride/co-acrylic acid), poly(acrylamide-methacrylamidopropyltrimethyl ammonium chloride), poly(acrylamide-methacrylamidopropyltrimethyl ammonium chloride/co-acrylic acid), poly(acrylamide-co-diallyldimethylammonium chloride/co-acrylic acid), poly(acrylamide-co-N,N, N-trimethyl aminoethyl acrylate), poly(diallyldimethylammonium chloride/co-vinyl alcohol), poly (diallyldimethylammonium chloride/acrylamide), and mixtures thereof. The diallyldimethylammonium chloride and co-acrylic acid monomers can be present in a mol ratio of from 50:50 to 90:10, preferably from 55:45 to 85:15, more preferably from 60:40 to 70:30. For poly(diallyldimethylammonium chloride/co-acrylic acid) the preferred ratio of diallyldimethylammonium chloride to acrylic acid is between approximately 90:10 and 50:50. The preferred cationic polymer is poly (diallyldimethylammonium chloride/co-acrylic acid) copolymer at a 65/35 mole ratio with a molecular weight of approximately 450,000. Poly (diallyldimethylammonium chloride/co-acrylic acid) copolymer may be further described by the nomenclature Polyquaternium-22 or PQ22 as named under the International Nomenclature for Cosmetic Ingredients. Poly (diallyldimethylammonium chloride/acrylamide) may be further described by the nomenclature Polyquaternium-7 or PQ7 as named under the International Nomenclature for Cosmetic Ingredients.

“Fabric care benefit agent” as used herein refers to any material that can provide fabric care benefits. Non-limiting examples of fabric care benefit agents include: silicone derivatives, oily sugar derivatives, dispersible polyolefins, polymer latexes, cationic surfactants and combinations thereof. Preferably, the deposition aid is a cationic or amphoteric polymer. The cationic charge density of the polymer preferably ranges from 0.05 milliequivalents/g to 6.0 milliequivalents/g. The charge density is calculated by dividing the number of net charge per repeating unit by the molecular weight of the repeating unit. In one embodiment, the charge density varies from 0.1 milliequivalents/g to 3.0 milliequivalents/g. The positive charges could be on the backbone of the polymers or the side chains of polymers.

Dye transfer inhibiting polymers: The detergent composition can comprise one or more dye transfer inhibiting polymer. However, preferred compositions do not comprise such dye transfer inhibiting polymers. It has been found that during laundering, many fabric-dyes partition between the fabric and wash-liquor. As such, the sequestering of dyes in the wash liquor using DTI polymers has been found to increase dye removal from fabrics, and hence increase dye-fading.

When used, suitable dye transfer inhibiting can be selected from the group consisting of polyvinylpyrrolidone (PVP), polyvinylimidazole (PVI), copolymers of vinylpyrrolidone and vinylimidazole (PVP/PVI), polyvinyl pyridine-N-oxide, poly-N-carboxymethyl-4-vinylpyridiumchloride, poly(2-hydroxypropyldimethylammonium chloride), and mixtures thereof, preferably polyvinylpyrrolidone (PVP), polyvinylimidazole (PVI), copolymers of vinylpyrrolidone and vinylimidazole (PVP/PVI), and mixtures thereof. If present, the dye transfer inhibitor can be present at a level of from 0.05% to 5%, or from 0.1% to 3%, and or from 0.2% to 2.5%, by weight of the detergent composition.

Polyvinylpyrrolidone (“PVP”) has an amphiphilic character with a highly polar amide group conferring hydrophilic and polar attracting properties, and also has apolar methylene and methane groups, in the backbone and/or the ring, conferring hydrophobic properties. The rings may also provide planar alignment with the aromatic rings, in the dye molecules. PV P is readily soluble in aqueous and organic solvent systems. PV P is commercially available in either powder or aqueous solutions in several viscosity grades. The compositions of the present invention preferably utilize a copolymer of N-vinylpyrrolidone and N-vinylimidazole (also abbreviated herein as “PVPVI”). It has been found that copolymers of N-vinylpyrrolidone and N-vinylimidazole can provide excellent dye transfer inhibiting performance. The copolymers of N-vinylpyrrolidone and N-vinylimidazole can have a molar ratio of N-vinylimidazole to N-vinylpyrrolidone from 1:1 to 0.2:1, more preferably from 0.8:1 to 0.3:1, most preferably from 0.6:1 to 0.4:1. The copolymer of N-vinylpyrrolidone and N-vinylimidazole can be either linear or branched. Particularly suitable polyvinylpyrrolidones (PVP), polyvinylimidazoles (PVI), and copolymers of vinylpyrrolidone and vinylimidazole (PVP/PVI), can have a weight average molecular weight of from 5,000 Da to 1,000,000 Da, preferably from 5,000 Da to 50,000 Da, more preferably from 10,000 Da to 20,000 Da. The number average molecular weight range is determined by light scattering as described in Barth J. H. G. and Mays J. W. Chemical Analysis Vol 113. “Modern Methods of Polymer Characterization.” Copolymers of poly (N-vinyl-2-pyrollidone) and poly (N-vinyl-imidazole) are commercially available from a number of sources including BASF. A preferred DTI is commercially available under the tradename Sokalan® HP 56 K from BASF (BASF SE, Germany).

Organic builder and/or chelant: The laundry detergent composition can comprise from 0.6% to 10%, preferably from 2.0 to 7.0% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy diphosphonates, and nitrilotrimethylene, phosphonates, diethylene triamine penta (methylene phosphonic acid) (DTPMP), ethylene diamine tetra(methylene phosphonic acid) (EDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulphonates such as Tiron™ and mixtures thereof.

Enzymes: Suitable enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, mannanase, pectinase, cutinase and/or cellulase in conjunction with amylase. Detersive enzymes are described in greater detail in U.S. Pat. No. 6,579,839.

Enzyme stabiliser: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, dialkyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Hueing dyes: The detergent composition may comprise fabric hueing agent (sometimes referred to as shading, bluing, or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and combinations thereof.

Optical brighteners: The detergent composition may comprise, based on the total detergent composition weight, from 0.005% to 2.0%, preferably 0.01% to 0.1% of a fluorescent agent (optical brightener). Fluorescent agents are well known and many fluorescent agents are available commercially. Usually, these fluorescent agents are supplied and used in the form of their alkali metal salts, for example, the sodium salts. Preferred classes of fluorescent agent are: Di-styryl biphenyl compounds, e.g. Tinopal® CBS-X, Di-amine stilbene di-sulphonic acid compounds, e.g. Tinopal® DMS pure Xtra and Blankophor® HRH, and Pyrazoline compounds, e.g. Blankophor® SN. Preferred fluorescers are: sodium 2-(4-styryl-3-sulphophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphoslyryl)biphenyl.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulphonate, toluene sulphonate, xylene sulphonate or cumene sulphonate. Preferably, the hydrotrope is selected from the group consisting of propylene glycol, xylene sulphonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4.0%, more preferably from 0.25% to 2.5% of particles. Said particles include beads, pearlescent agents, capsules, and mixtures thereof.

Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

### Process of Making the Laundry Detergent Composition:

The laundry detergent compositions can be made using any suitable process known to the skilled person. Typically, the ingredients are blended together in any suitable order. Preferably, the detersive surfactants are added as part of a concentrated premix, to which are added the other optional ingredients. Preferably, the solvent is added either last, or if an external structurant is added, immediately before the external structurant, with the external structurant being added as the last ingredient.

### Method of Laundering Fabrics:

The laundry detergent compositions of the present invention are used to launder fabrics. In such methods and uses, the laundry detergent composition can be diluted to provide a wash liquor having a total surfactant concentration of greater than 300 ppm, preferably from 400 ppm to 2,500 ppm, more preferably from 600 ppm to 1000 ppm. The fabric is then washed in the wash liquor, and preferably rinsed.

### Methods

### A) pH Measurement:

The pH is measured, at 25° C., using a Santarius PT-10P pH meter with gel-filled probe (such as the Toledo probe, part number 52 000 100), calibrated according to the instruction manual. The pH is measured in a 10% dilution in demineralised water (i.e. 1 part laundry detergent composition and 9 parts demineralised water).

### B) Measuring Viscosity:

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s⁻¹ to 1200 s⁻¹ in 3 minutes time at 20° C. Low shear viscosity is measured at a continuous shear rate of 0.05 s⁻¹.

### EXAMPLES

The liquid laundry detergent compositions of table 1 were prepared by mixing the ingredients together and agitating for at least 30 minutes.

A tergotometer was used to simulate the washing of fabrics in a top-load “High Efficiency” washing machine. The test compositions were used to wash the technical stained swatches (9 grams of swatches per load) together with soiled fabric (4 grams of fabric per load using 6 cm×6 cm 100% cotton SBL2004 supplied by WFK Germany) and clean knitted cotton ballast (47 grams per load). The technical stain swatches of CW120 cotton containing stains were purchased from Advanced Product Design Co., Inc (Cincinnati, OH). The wash tests consisted of two internal and four external replicates for each stain type and treatment.

The test fabrics, soiled fabric and clean fabric ballast were washed with 0.66 grams of the liquid detergent compositions and 1.0 L of water having 8 gpg (1.37 mmol/l calcium equivalence) hardness, at 15° C. under agitated at 208 rpm for 17 minutes in the tergometer pots, before being spun dry. The fabrics were then rinsed in water having 8 gpg (1.37 mmol/l calcium equivalence) hardness at 15° C. at 200 rpm for 5 minutes and then spun dry. The fabrics were then machine dried (Whirlpool Model LER3622PQ2) on the high setting for 40 minutes before being analysed.

Image analysis was used to compare each stain to an unstained control fabric. Software was used to convert the images into standard colorimetric values and the values compared to the standards based on the commonly used Macbeth Color Rendition Chart, assigning each stain a colorimetric value (Stain Level). 2 internal replicates and 4 external replicates of each stain were prepared and analysed.

Stain removal from the swatches was measured as follows:

$$Stain Removal Index ( \% SRI ) = \frac{[ Δ {E}_{initial} - {E}_{washed} ]}{Δ {E}_{initial}} \times 100$$

The results are given in table 2.

TABLE 1
Inventive and comparative laundry detergent compositions.

| | Ex 1 | Ex 2 | Ex A * |
|---|---|---|---|
| | wt % | wt % | wt % |
| C10-C13 linear alkyl benzene sulphonate | 20.0 | 20.0 | 20.0 |
| C12-C14 amido ethyl sulfate anionic surfactant | 8.0 | — | — |
| C12-C14 amido isopropyl sulfate anionic surfactant | — | 8.0 | — |
| C12-C14 alkyl sulfate anionic surfactant | — | — | 8.0 |
| C14-C15 EO7 nonionic surfactant | 4.0 | 4.0 | 4.0 |
| C13-15 EO10 nonionic surfactant¹ | 12.0 | 12.0 | 12.0 |
| 1,2-propanediol | 18.0 | 18.0 | 18.0 |
| Glycerine | 6.0 | 6.0 | 6.0 |
| Ethoxylated polyethyleneimine² | 2.25 | 2.25 | 2.25 |
| Ethoxylated propoxylated polyethyleneimine³ | 2.25 | 2.25 | 2.25 |
| Tetrasodium glutamate diacetate (GLDA) | 1.0 | 1.0 | 1.0 |
| Monoethanolamine | 3.0 | 3.0 | 3.0 |
| Mannanase enzyme (wt % active protein) ⁴ | 0.008 | 0.008 | 0.008 |
| Amylase enzyme (wt % active protein) ⁵ | 0.040 | 0.040 | 0.040 |
| Protease enzyme (wt % active protein) ⁶ | 0.131 | 0.131 | 0.131 |
| Pectate lyase enzyme (wt % active protein) ⁷ | 0.006 | 0.006 | 0.006 |
| Water | to 100% | to 100% | to 100% |
| pH (measured for a 10% dilution of product into | 7.35 | 7.31 | 7.47 |
| deionized water at 20° C.) | | | |

* comparative
¹Exxal 1315 LE alcohol, supplied by ExxonMobil, and reacted using KOH catalyst with ethylene oxide to an average of 10 moles of ethylene oxide per mole of alcohol
²Polyethyleneimine polymer having a molecular weight of 600 g/mol, ethoxylated to a weight average degree of 20, supplied by BASF
³Polyethyleneimine polymer having a molecular weight of 600 g/mol, ethoxylated to a weight average degree of 24 and propoxylated to a weight average degree of 16, supplied by BASF
⁴ Mannanase available from Novonesis, Copenhagen, Denmark
⁵ Amylase enzyme available from Novonesis
⁶ Protease available from DuPont-Genencor, Palo Alto, CA
⁷ Pectate lyase enzyme available from Novonesis

TABLE 2
Hydrophobic stain removal results (% SRI) after laundering using
inventive and comparative laundry detergent compositions.

| | Ex 1 | Ex 2 | Ex A * |
|---|---|---|---|
| | % SRI | % SRI | % SRI |
| Bacon grease (dyed) | 52.8 | 50.3 | 50.0 |
| Burnt butter | 52.3 | 49.2 | 46.4 |
| Cooked beef | 39.2 | 32.6 | 32.1 |
| Makeup (Covergirl ®) | 31.0 | 34.0 | 27.5 |

Formulating the laundry detergent composition using alkyl sulfate anionic surfactant (non-ethoxylated) as in comparative example A, or an alkyl alkanolamide sulfate anionic surfactant as in inventive example 1 and 2, all result in the elimination of 1,4-dioxanes, in contrast to prior art laundry detergent compositions formulated using a combination of sulfonate anionic surfactant and alkyl ethoxylated sulfate anionic surfactant.

From comparing the results after laundering, using inventive composition 1 or inventive composition 2 which comprise alkyl alkanolamide sulfate anionic surfactant in combination with a sulfonate surfactant is seen to result in improved removal of hydrophobic stains, in comparison to comparative composition A which comprises alkyl sulfate anionic surfactant and the sulfonate surfactant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A liquid laundry detergent composition comprising a surfactant system, wherein the surfactant system comprises anionic surfactant, wherein the anionic surfactant comprises a combination of alkyl alkanolamide sulfate anionic surfactant and sulfonate anionic surfactant, wherein alkyl alkanolamide sulfate anionic surfactant has the formula: 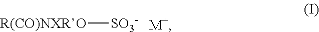
wherein:
R is an alkyl chain comprising a number average of from 7 to 17 carbon atoms;
R′ is an alkyl chain comprising a number average of from 1 to 3 carbon atoms;
X is H or C1 to C3 alkyl; and
M⁺ is a counterion.

2. The laundry detergent composition according to claim 1, wherein the composition comprises the surfactant system at a level of from 2.5% to 60%, by weight of the composition.

3. The laundry detergent composition according claim 1, wherein the surfactant system comprises anionic surfactant at a level of from 2.0% to 50% of the liquid laundry detergent composition.

4. The laundry detergent composition according to claim 1, wherein the sulfonate anionic surfactant is present at a level of from 30% to 90%, by weight of the surfactant system.

5. The laundry detergent composition according to claim 1, wherein the sulfonate anionic surfactant is present at a level of at least 55%, by weight of the anionic surfactant.

6. The laundry detergent composition according to claim 1, wherein the anionic surfactant comprises the sulfonate anionic surfactant and the alkyl alkanolamide sulfate anionic surfactant in a weight ratio of from 55:45 to 99:1.

7. The laundry detergent composition according to claim 1, wherein the sulphonate anionic surfactant is selected from the group consisting of: alkylbenzene sulphonates, alkyl ester sulphonates, alkane sulphonates, alkyl sulphonated polycarboxylic acids, and mixtures thereof, preferably alkylbenzene sulphonates, more preferably C10-C16 alkylbenzene sulphonates.

8. The composition according to claim 1, wherein in for the alkyl alkanolamide sulfate anionic surfactant of formula (I):
R is an alkyl chain comprising a number average of from 9 to 13, preferably from 11 to 13 carbon atoms, most preferably R is a blend of C11 and C13 alkyl chains;
R′ is an alkyl chain comprising a number average of from 2 to 3 carbon atoms, more preferably wherein R′ is selected from the group consisting of: —(CH₂)₂—, —CH₂CH(CH₃)—, —CH(CH₃)CH₂—;
X is H or C1 alkyl, preferably H or methyl,
M⁺ is an alkali metal counterion or ammonium, ethanolamine, or isopropanolamine, more preferably Na⁺, or K⁺, Mg²⁺, or ethanolamine, most preferably Na⁺.

9. The composition according to claim 1, wherein in the alkyl alkanolamide sulfate anionic surfactant, the alkyl chain R has a mole percentage of C13 alkyl chains to total alkyl chains of at least 20%.

10. The composition according to claim 1, wherein in the alkyl alkanolamide sulfate anionic surfactant, the alkyl chain R has a mole percentage of C15 and C17 alkyl chains to total alkyl chains of less than 40%.

11. The composition according to claim 1, wherein in the alkyl alkanolamide sulfate anionic surfactant, the molar ratio of C13 to C11 alkyl chains in R is from 3:1 to 1:4.

12. The composition according to claim 1, wherein the alkyl alkanolamide sulfate anionic surfactant comprises C12 alkyl alkanolamide sulfate anionic surfactant, C14 alkyl alkanolamide sulfate anionic surfactant, and mixtures thereof,
wherein:
the C12 alkyl alkanolamide sulfate anionic surfactant is selected from the group consisting of: N-(2-hydroxyethyl)dodecanamide sulfate, N-(2-hydroxypropyl)dodecanamide sulfate, N-(2-hydroxyethyl)-N-methyldodecanamide sulfate, N-(1-hydroxypropan-2-yl)dodecanamide sulfate, and mixtures thereof, preferably N-(2-hydroxyethyl)dodecanamide sulfate, N-(2-hydroxypropyl)dodecanamide sulfate, N-(2-hydroxyethyl)-N-methyldodecanamide sulfate, and mixtures thereof; and
the C14 alkyl alkanolamide sulfate anionic surfactant is selected from the group consisting of: N-(2-hydroxyethyl)tetradecanamide sulfate, N-(2-hydroxypropyl)tetradecanamide sulfate, N-(2-hydroxyethyl)-N-methyltetradecanamide sulfate, N-(1-hydroxypropan-2-yl) tetradecanamide sulfate, and mixtures thereof, preferably N-(2-hydroxyethyl) tetradecanamide sulfate, N-(2-hydroxypropyl) tetradecanamide sulfate, N-(2-hydroxyethyl)-N-methyltetradecanamide sulfate, and mixtures thereof.

13. The composition according to claim 1, wherein the anionic surfactant further comprises alkyl sulfate anionic surfactant and the alkyl sulfate anionic surfactant has a number average alkyl chain length of from 10 to 18.

14. The composition according to claim 13, wherein the alkyl sulfate anionic surfactant has an average degree of alkoxylation of less than 3.0.

15. The composition according to claim 13, wherein the alkyl sulfate anionic surfactant and the alkyl alkanolamide sulfate anionic surfactant are present at a weight ratio of from 10:1 to 1:2.
